(19) United States
(12) Patent Application Publication
(10) Pub. No.: US 2026/0288078 A1
(43) Pub. Date: Sep. 24, 2026

(54) HAND MOVEMENT CONTROL DEVICE, ELECTRONIC TIMEPIECE, HAND MOVEMENT CONTROL METHOD, AND STORAGE MEDIUM

(71) Applicant: CASIO COMPUTER CO., LTD., Tokyo (JP)

(72) Inventor: Mitsuaki MATSUO, Tokyo (JP)

(73) Assignee: CASIO COMPUTER CO., LTD., Tokyo (JP)

(21) Appl. No.: 19/571,297

(22) Filed: Mar. 18, 2026

(30) Foreign Application Priority Data
Mar. 24, 2025 (JP) 2025-048774

(51) Int. Cl. G04C 9/08; G04C 3/14

(52) U.S. Cl. CPC G04C 9/08; G04C 3/14

(57) ABSTRACT

A hand movement control device includes a processor configured to, in a case of causing a hand to perform a display operation synchronized with time, output, to a driver, a signal to cause the hand to perform a rotational movement by a unit angle per unit period obtained by dividing a reference period by two or more. The signal includes a first signal for the hand to perform the movement each time the reference period elapses based on a current time and a second signal for the hand to perform the movement each time the unit period elapses from a timing of the movement caused by the first signal. The processor causes the hand to move to a position for a first point in time that is ahead of the current time and in units of the reference period and starts controlling the display operation from the first point in time.

### BACKGROUND OF THE INVENTION

### Technical Field

The present disclosure relates to a hand movement control device, an electronic timepiece, a hand movement control method, and a storage medium.

### Description of Related Art

As a timepiece including a hand(s), there is an electronic timepiece that can switch time zones for which time (a point in time) is displayed or can execute and display a function other than the time display. There is also an electronic timepiece having a function to obtain the right time from the outside to correct displayed time. JP 2014-032067 A discloses, when switching to the right current time display from other display, fast-forwarding a hand(s) to promptly change its position.

### SUMMARY OF THE INVENTION

According to an aspect of the present disclosure, there is provided a hand movement control device including a processor configured to, in a case of causing a hand to perform a display operation synchronized with time, output, to a driver, a signal to cause the hand to perform a rotational movement by a unit angle per unit period obtained by dividing a reference period by an integer of two or more,
wherein the signal includes a first signal to cause the driver to cause the hand to perform the rotational movement each time the reference period elapses based on a current time measured by a timing module, and a second signal to cause the driver to cause the hand to perform the rotational movement each time the unit period elapses from a timing of the rotational movement caused by the first signal, and
wherein in a case of causing the hand to move to a position corresponding to the current time and start the display operation, the processor causes the hand to move to a position corresponding to a first point in time that is ahead of the current time and in units of the reference period and starts controlling the display operation from the first point in time.

Further features of the present invention will become apparent from the following description of exemplary embodiments (with reference to the attached drawings).

### BRIEF DESCRIPTION OF DRAWINGS

FIG. 1 is a block diagram showing a functional configuration of an electronic timepiece of an embodiment(s).

FIG. 2A illustrates movement timings of a second hand.

FIG. 2B illustrates movement timings of the second hand.

FIG. 3 is a flowchart showing a control procedure for a sweep movement control process.

FIG. 4 illustrates how to return to time display.

FIG. 5 is a flowchart showing a control procedure for a return-to-time-display process.

FIG. 6 is a flowchart showing a control procedure for a return-to-time-display process of another embodiment.

FIG. 7 is a flowchart showing a control procedure for a return-to-time-display process of another embodiment.

### DETAILED DESCRIPTION

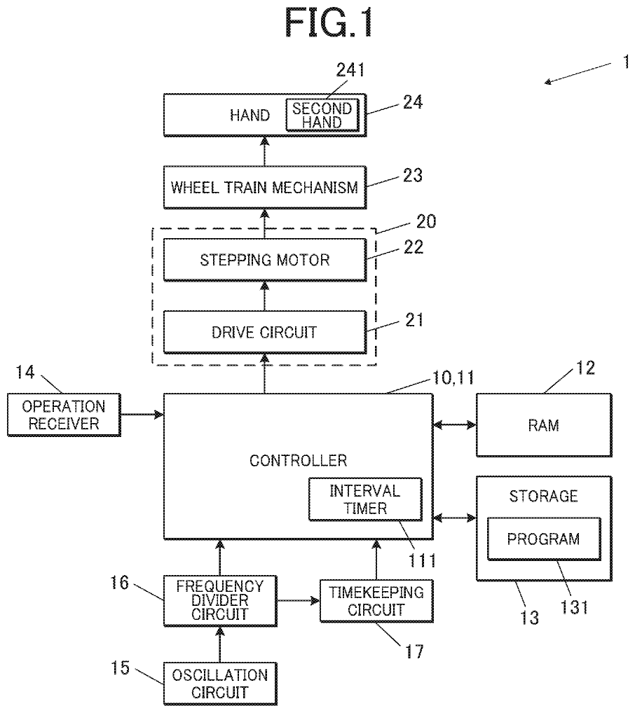

Hereinafter, one or more embodiments of the present disclosure will be described on the basis of the drawings. As shown in the block diagram of FIG. 1, an electronic timepiece 1 includes a controller 11, a random access memory (RAM) 12, a storage 13, an operation receiver 14, an oscillation circuit 15, a frequency divider circuit 16, a timekeeping circuit 17 (timing module), a drive circuit 21, a stepping motor 22, a wheel train mechanism 23, and a hand 24. The electronic timepiece 1 may be a portable electronic timepiece, such as a wristwatch.

The controller 11 has a processor that controls the overall operation of the electronic timepiece 1. The processor may be a general-purpose central processing unit (CPU), or may be a microcontroller, an integrated circuit (IC), a large-scale integrated circuit (LSI) or the like suitable for operating a timepiece. The controller 11 may have a single processor, or may have multiple processors that independently perform processes depending on the application or the like. Alternatively, the multiple processors may work together to perform processes in parallel. The controller 11 includes an interval timer 111. The interval timer 111 may not be a hardware component, and simply the controller 11 may count clock signals to calculate/measure the elapsed time. The interval timer 111 starts the counting/measurement in response to a trigger and outputs an interrupt signal when having measured a specified time. Hereinafter, this interrupt signal may be referred to as a “timer interrupt”.

The RAM 12 provides the controller 11 with a memory space for work and stores temporary data. The RAM 12 stores, for example, data of the number of movements of the hand 24 per second.

The storage 13 has a nonvolatile memory and stores programs 131, setting data, and so forth. The nonvolatile memory may be, for example, a flash memory. As long as it is usable as a nonvolatile memory, the type of nonvolatile memory is not specifically limited.

The operation receiver 14 receives input operations from the outside and outputs, to the controller 11, operation signals corresponding to the contents of the received input operations. The operation receiver 14 may have, for example, a pushbutton switch. The operation receiver 14 may also have a crown, a slide switch, and another operation mechanism.

The oscillation circuit 15 includes, for example, a quartz crystal resonator and a resonance circuit, and generates clock signals of around the resonant frequency of the quartz crystal resonator. The resonant frequency may be, for example, 32.768 kHz or 16.384 kHz. This frequency changes depending on the environmental conditions, such as temperature, in addition to the adjustment accuracy of the quartz crystal resonator. The quartz crystal resonator may be an AT-cut crystal that is stable around room temperature against temperature change. The frequency divider circuit 16 divides the frequency of the clock signals to obtain signals of an appropriate frequency and outputs the frequency-divided signals. The frequency of the frequency-divided signals may be multiple and determined in accordance with the frequency necessary for each component of the electronic timepiece 1. The frequency-divided signals may include a 1-Hz signal for measuring the date and time, i.e., a one-second (reference period) signal.

The timekeeping circuit 17 may count 1-Hz signals to obtain the current date and the current time, i.e., the date and time, in units of one second (reference period). In other words, the timekeeping circuit 17 does not measure fractions of a second. The operation of the timekeeping circuit 17 may be included in the software operation of the controller 11. In other words, the electronic timepiece 1 may not have the timekeeping circuit 17 as a hardware component. Separate from the operation of the controller 11 as the timekeeping circuit 17, the electronic timepiece 1 may have a real time clock (RTC) as a hardware component.

The drive circuit 21 outputs drive pulses to the stepping motor 22 based on the control by the controller 11. The stepping motor 22 rotates/moves by a specific angle in response to each input drive pulse. The wheel train mechanism 23 is a gear train that converts the rotation of the stepping motor 22 into rotation of the hand 24. The hand 24 is a needle-like object used for a display operation synchronized with time, mainly for time display, and rotates (moves or performs a rotational movement) on a plane along the display surface of the electronic timepiece 1 in response to the operation of the wheel train mechanism 23, i.e., the operation of the stepping motor 22. The hand 24 may include a second hand 241, a minute hand, and an hour hand. The hand 24 may include a hand(s) other than the second hand 241, the minute hand, and the hour hand. The other hand may have a rotation axis at a position different from that of the second hand 241, the minute hand and the hour hand. The drive circuit 21 and the stepping motor 22 correspond to a driver 20 of this embodiment. The drive circuit 21 is capable of outputting drive pulses for fast-forwarding the hand 24. The fast-forwarding speed may be, for example, 32 to 90 steps per second. The fast-forwarding speed may differ between when the hand 24 is moved in the forward direction, i.e., clockwise, and when it is moved in the reverse direction, i.e., counterclockwise.

Next, a hand movement control method for the hand 24 of the electronic timepiece 1 of this embodiment will be described. As described above, in the electronic timepiece 1, time is displayed by the rotations of the second hand 241, the minute hand and the hour hand. At least the second hand 241 performs rotational movements independently of the other hands. The second hand 241, the minute hand and the hour hand may be caused to perform the rotational movements independently of one another by their respective stepping motors 22 and wheel train mechanisms 23. Alternatively, the minute hand and the hour hand may rotate in conjunction with one another. In other words, the electronic timepiece 1 may have a wheel train mechanism 23 that rotates the hour hand by a rotation angle equal to 1/12 of that of the minute hand in response to the operation of their common stepping motor 22.

In the time display operation, the second hand 241 of the electronic timepiece 1 performs the rotational movements at intervals shorter than the reference period of one second, making one revolution per minute on the display surface. The interval(s) (unit time(s)) between the rotational movements of the second hand 241 may be, for example, a time (period or time length) obtained by dividing the reference period by an integer of two or more, 12 in this embodiment, i.e., may be about 1/12 seconds. A typical second hand, which performs one rotational movement per second, rotates six degrees at a time. In contrast, the second hand 241 of this embodiment may rotate an angle obtained by dividing six degrees by 12, i.e., 0.5 degrees, at a rotational movement. In other words, the second hand 241 may perform 12 rotational movements per second, and a unit angle that the second hand 241 rotates at one rotational movement may be 0.5 degrees. The rotational movements at such fine, substantially uniform intervals appear to the user to be smooth rotation, and are referred to as “sweep movement”. The minute hand and the hour hand may rotate in their typical manners. For example, the minute hand may perform one rotational movement every ten seconds, and the hour hand may perform one rotational movement every two minutes.

A typical electronic timepiece outputs a synchronization signal at the timing of each exact second, which has a decimal point of zero, and measures time and moves a second hand (and so forth). The electronic timepiece 1 of this embodiment, in addition to the above, repeatedly measures, with the interval timer 111, the interval between the rotational movements of the second hand 241, which hereinafter may be referred to as “hand movements”, in each second, thereby determining the timing of each rotational movement of the second hand 241 other than the timing of second synchronization thereof. In other words, the electronic timepiece 1 does not raise the output frequency of synchronization signals according to the number of rotational movements of the second hand 241.

Thus, the electronic timepiece 1 keeps conventional-and-accurate second synchronization signals, and determines the hand-movement timings of less than one second while synchronizing some of the hand movements and a timekeeping process with the signals. In this case, even when the hand-movement timings for a unit number of times, which is the number of rotational movements of less than one second, slightly deviate from exact reference intervals, the deviations are initialized and eliminated at the timing of a second synchronization signal. This prevents deviations in measuring time from being cumulated. Therefore, the accuracy of a time measured by the interval timer 111 may not be high as long as the intervals between the rotational movements of the second hand 241 do not appear to the user to be unnatural. In particular, even if a reference interval(s) is defined by the reciprocal of a frequency containing a multiple of a prime number other than 2, it is unnecessary to raise the frequency to improve the accuracy. Accordingly, the electronic timepiece 1 can suppress increases in manufacturing and operational costs and power consumption.

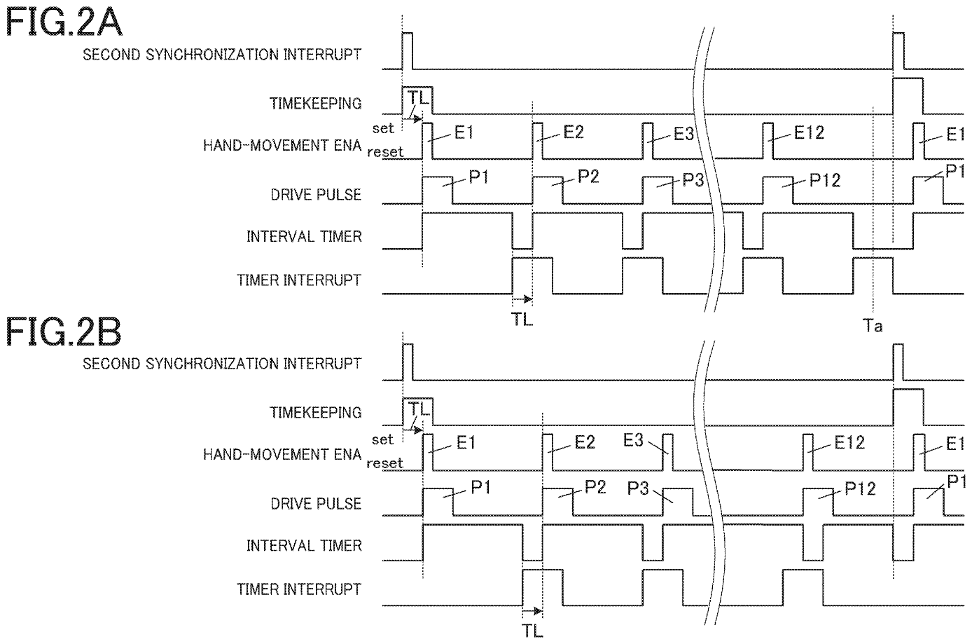

FIG. 2A and FIG. 2B illustrate timings for the sweep movement, in which the second hand 241 performs 12 rotational movements per second. In the electronic timepiece 1, the operation (movement) of the second hand 241 is controlled by an interrupt process based on second synchronization signals and an interrupt process with the interval timer 111 measuring about 1/12 seconds. When a second synchronization signal is output, an interrupt signal occurs and the timekeeping process is performed to update the current date and time. With this, a hand-movement enable signal (ENA), which enables the rotational movement of the second hand 241, is set, for example, to be a high level, and is output to the drive circuit 21 as a first signal. The hand-movement enable signal may be a flag set in the drive circuit 21. A drive pulse is output from the drive circuit 21 to the stepping motor 22. In synchronization with this drive pulse, the interval timer 111, which measures about 1/12 seconds, starts the measurement. Although 1/12 seconds are 83.3 milliseconds, the intervals (unit periods) at which the drive pulse is output may deviate from this as described above. For example, the unit period(s) may be around 81 to 85 milliseconds.

It is noted, in practice, there is a time lag TL between when an interrupt signal related to a hand movement is input and when a drive pulse is actually output. Therefore, the interval timer 111 may measure a time obtained by subtracting a time corresponding to this time lag TL from the unit period, as a standby period before starting a process for outputting the next drive pulse. For example, the standby period may be about 80 milliseconds. When the drive pulse is output from the drive circuit 21 to the stepping motor 22 in response to the set hand-movement enable signal, the hand-movement enable signal is reset, for example, to be a low level.

When the interval timer 111 measures the standby period, an interrupt signal is output. Based on a timer interrupt related to this interrupt signal, each time the unit period elapses, the controller 11 sets the hand-movement enable signal, which enables the rotational movement of the second hand 241, and outputs it as a second signal to the drive circuit 21. Accordingly, the drive circuit 21 outputs the drive pulse. In other words, the first hand movement in each second is based on a second synchronization signal, and a hand-movement enable signal E1 is the first signal. The second to 12^{th} hand movements in each second are each based on a timer interrupt corresponding to the measurement by the interval timer 111, and hand-movement enable signals E2 to E12 are each the second signal. The timekeeping process may not be performed in response to the timer interrupt. In other words, the timekeeping circuit 17 may measure time in units of one second.

As shown in FIG. 2A, the controller 11 counts the number of times the hand-movement enable signal is set, i.e., the number of set times of hand-movement enable signals (E1 to E12), or the number of times the drive pulse is output, i.e., the number of output times of drive pulses (P1 to P12), in each second. The controller 11 sets no hand-movement enable signal after the 12^{th} hand-movement enable signal E12 or the 12^{th} drive pulse P12 is output in each second. If the output interval(s) (reference interval(s)) of the drive pulses is shorter than 83.3 milliseconds, after the 12^{th} drive pulse P12 is output, the 13^{th} timer interrupt occurs. The controller 11 sets no hand-movement enable signal at a timing Ta corresponding to the 13^{th} timer interrupt. Therefore, no drive pulse is output from the drive circuit 21 in response to the 13^{th} timer interrupt or any subsequent timer interrupt. When one second elapses and the next second synchronization signal is input, the counted value of the number of times the hand-movement enable signal is set or the number of times the drive pulse is output is initialized to be counted again from “1”. With this, a hand-movement enable signal corresponding to that next second synchronization interrupt is set.

On the other hand, as shown in FIG. 2B, if the output interval(s) of the drive pulses is longer than 83.3 milliseconds, after the 12^{th} drive pulse P12 is output, a second synchronization interrupt accompanying a second synchronization signal occurs while the interval timer 111 is measuring the standby period. In this case, the measurement by the interval timer 111 is stopped even if it is in progress, and the counted value of the number of times the hand-movement enable signal is set or the number of times the drive pulse is output is initialized. In response to a hand-movement enable signal E1 or a drive pulse P1 based a second synchronization interrupt, the number of times the hand-movement enable signal is set or the number of times the drive pulse is output is counted again from “1”.

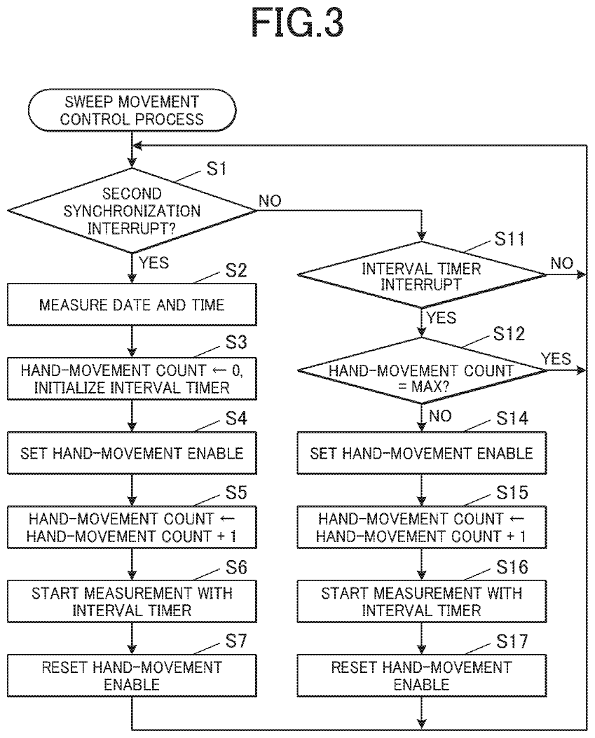

As shown in the flowchart of FIG. 3, part of the above procedure is performed as software control by the controller 11 with respect to the interrupt processes. The controller 11 determines whether there has been an interrupt signal for second synchronization (S1). If the controller 11 determines that there has been an interrupt signal for second synchronization (S1; YES), the controller 11 measures the date and time (S2). The controller 11 adds one second to the current date and time. The controller 11 initializes a hand-movement count (i.e., the number of rotational movements of the second hand 241) within a second to zero and initializes the measurement by the interval timer 111 (S3).

The controller 11 sets a hand-movement enable signal (S4). Accordingly, the drive circuit 21 outputs a drive pulse to the stepping motor 22. The controller 11 adds “1” to the hand-movement count for the second (S5). The controller 11 starts the measurement with the interval timer 111 (S6). The controller 11 resets the hand-movement enable signal (S7). The controller 11 then returns to Step S1.

If the controller 11 determines that there has been no interrupt signal for second synchronization (S1; NO), the controller 11 determines whether there has been an interrupt signal from the interval timer 111 (S11). If the controller 11 determines that there has been no interrupt signal from the interval timer 111 (S11; NO), the controller 11 returns to Step S1.

If the controller 11 determines that there has been an interrupt signal from the interval timer 111 (S11; YES), the controller 11 determines whether the hand-movement count is the maximum value MAX, “12” in this embodiment (S12). If the controller 11 determines that the hand-movement count is the maximum value MAX (S12; YES), the controller 11 returns to Step S1.

If the controller 11 determines that the hand-movement count is not the maximum value MAX (S12; NO), the controller 11 sets a hand-movement enable signal (S14). Accordingly, the drive circuit 21 outputs a drive pulse to the stepping motor 22. The controller 11 adds “1” to the hand-movement count (S15). The controller 11 starts the measurement with the interval timer 111 (S16). The controller 11 resets the hand-movement enable signal (S17). The controller 11 then returns to Step S1.

The measurement by the interval timer 111 may be started mechanically in conjunction with the output of a drive pulse to the stepping motor 22. Steps S1 to S7 and Steps S11 to S17 may be different processes that are started independently of one another with respect to their respective interrupts.

The electronic timepiece 1 may be capable of displaying contents other than time, depending on the function executable by the electronic timepiece 1. Examples of the displayable contents include an alarm time setting, On/Off of an alarm notification operation, a time zone setting for the current time to be displayed, switchable times (points in time) in multiple time zones, a numerical value or the like of a timer measuring a set time, a notification of a received email or SNS message from an external device, and an advanced notice of scheduled time (point in time). Display of each of these is temporary, and when finishes, returns to the current time display.

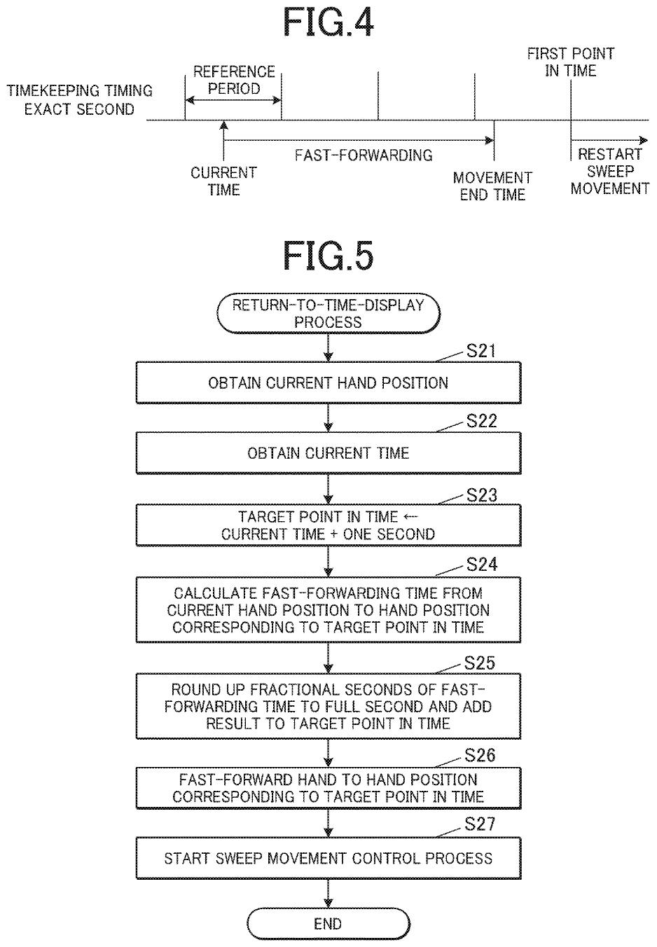

When display returns to the current time display, as described above, the hand 24 requires time to move to the current time. Therefore, if the hand 24 is moved to a position corresponding to the current time at the start of the movement, this current time already passes when the movement finishes. As shown in FIG. 4, the electronic timepiece 1 moves the hand 24 to a hand position corresponding to a point in time that is ahead of a point in time at which the movement of the hand 24 finishes. The time required for the movement of the hand 24 is obtained according to its movement speed and movement amount. The movement amount is obtained from hand positions before and after the movement. In the case of the aforementioned fast-forwarding speed, even if several seconds elapse during the fast-forwarding, a movement time corresponding to the movement amount of the hand 24 that could be added thereby is negligible. Therefore, the hand position after the movement may be approximated by the current time.

The timekeeping circuit 17 of the electronic timepiece 1 does not measure fractional seconds. Therefore, if a position corresponding to the timing of not an exact second is set as the destination of the second hand 241, the time display operation cannot be started at the right timing after the hand 24 reaches the position. The electronic timepiece 1 sets, as a first point in time, a point in time of an exact-second timing, i.e., a point in time defined in units of one second (reference period), that is ahead of the current time and can be reached by the hand 24 before it comes, based on the calculated required time. The hand 24 is fast-forwarded to a position corresponding to the first point in time as a target position. Starting to control the time display operation from the first point in time maintains the measurement and display of the right time thereafter.

As shown in FIG. 5, in a return-to-time-display process, the controller 11 obtains the current hand position (S21). The controller 11 obtains the current time from the timekeeping circuit 17 (S22). The controller 11 sets the current time plus one second, i.e., a point in time obtained by adding the reference period to the current time, as a target point in time (second point in time) for the destination of the hand 24 (S23). The controller 11 calculates a fast-forwarding time required by the hand 24 to move from the current hand position to a hand position corresponding to the target point in time (S24). The controller 11 rounds up the fractional seconds of the fast-forwarding time to a full second, and adds the result (second(s)) to the target point in time (S25).

The controller 11 outputs a control signal to the drive circuit 21 to fast-forward the hand 24 to the hand position corresponding to the obtained target point in time (S26). After completion of the fast-forwarding, the controller 11 starts the sweep movement control process described above (S27). In other words, the controller 11 waits for an interrupt signal corresponding to a second synchronization signal to start the sweep movement of the second hand 241. The controller 11 then ends the return-to-time-display process.

In the return-to-time-display process described above, the second synchronization may occur immediately after the hand 24 reaches the position corresponding to the target point in time, and accordingly the hand 24 may start moving without pausing substantially. In a return-to-time-display process of an embodiment, the target point in time may be set with a margin.

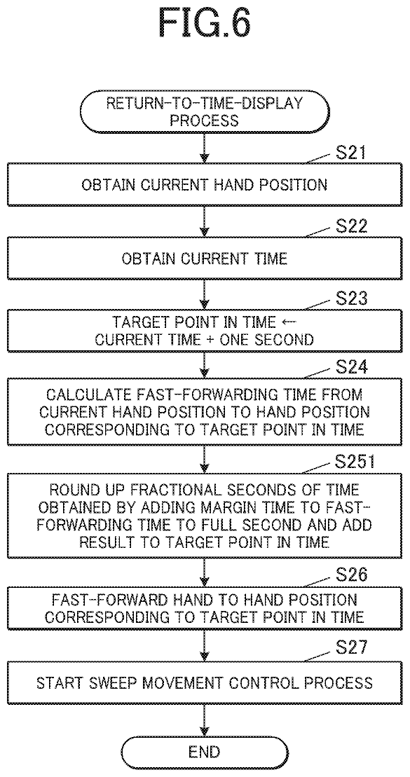

A return-to-time-display process of an embodiment shown in FIG. 6 is the same as that shown in FIG. 5 except that Step S25 is replaced by Step S251. The steps having the same contents as those in the return-to-time-display process shown in FIG. 5 are provided with the same step numbers, and their detailed descriptions will be omitted.

After Step S24, the controller 11 adds a predetermined margin time to the fast-forwarding time, rounds up fractional seconds of the obtained time to a full second, and adds the result (second(s)) to the target point in time (S251). The margin time may be, for example, 0.1 to 0.4 seconds. The controller 11 then moves to Step S26.

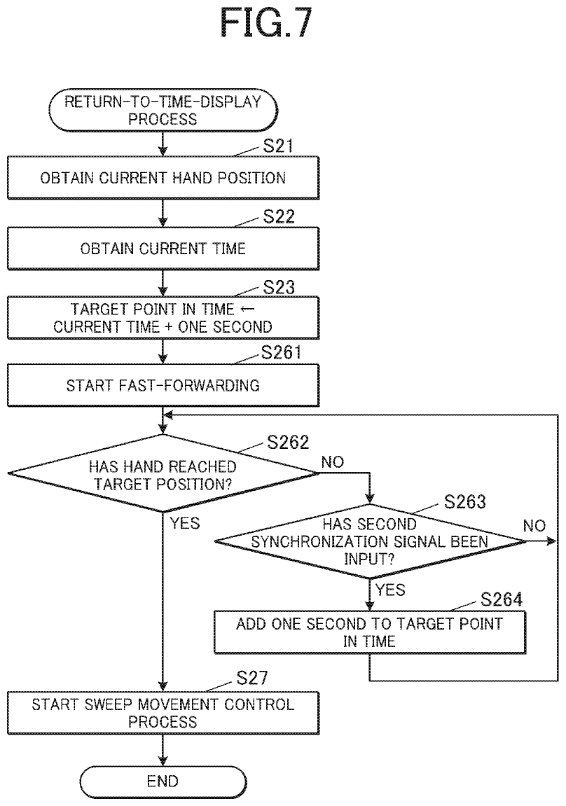

In each of the return-to-time-display processes shown in FIG. 5 and FIG. 6, the target point in time is set by obtaining the time required for fast-forwarding the hand 24 to the position corresponding to a provisional target point in time (second point in time) in advance, and based on the obtained required time, setting a final target point in time (first point in time) such that it does not arrive yet when fast-forwarding of the hand 24 finishes, but not limited thereto. If the target point in time comes during the fast-forwarding, the target point in time may be changed each time it occurs. The flowchart shown in FIG. 7 is the same as that shown in FIG. 5 except that Step S26 is replaced by Steps S261 to S264, and Steps S24 and S25 are removed. The steps having the same contents as those in the return-to-time-display process shown in FIG. 5 are provided with the same step numbers, and their detailed descriptions will be omitted.

When setting the target point in time in Step S23, the controller 11 outputs a control signal to the drive circuit 21 to start fast-forwarding the hand 24 to a hand position (target position) corresponding to the target point in time (S261). The controller 11 determines whether the hand 24 has reached the target position (S262). If the controller 11 determines that the hand 24 has reached the target position (S262; YES), the controller 11 moves to Step S27.

If the controller 11 determines that the hand 24 has not reached the target position (S262; NO), the controller 11 determines whether a second synchronization signal has been input (S263). If the controller 11 determines that no second synchronization signal has been input (S263; NO), the controller 11 returns to Step S262. If the controller 11 determines that a second synchronization signal has been input (S263; YES), the controller 11 adds one second to the target point in time (S264). The controller 11 then returns to Step S262.

As described above, the hand movement control device 10 of this embodiment(s) includes the controller 11. In a case of causing the second hand 241 to perform a display operation synchronized with time, the controller 11 outputs, to the driver 20, a signal to cause the second hand 241 to perform a rotational movement by a unit angle of 0.5 degrees per unit period, 1/12 seconds per unit period in this embodiment(s), which is obtained by dividing one second as a reference period by an integer of two or more. The signal to cause the second hand 241 to perform the rotational movement includes a first signal and a second signal. The first signal is a signal to cause the driver 20 to cause the second hand 241 to perform the rotational movement each time the reference period elapses based on the current time measured by the timekeeping circuit 17. The second signal is a signal to cause the driver 20 to cause the second hand 241 to perform the rotational movement each time the unit period elapses from the timing of the rotational movement caused by the first signal. In a case of causing the second hand 241 to move to a position corresponding to the current time and start the display operation, the controller 11 causes the second hand 241 to move to a position corresponding to a first point in time that is ahead of the current time and in units of the reference period and starts controlling the display operation from the first point in time. Thus, by causing the second hand 241 to perform the rotational movements including the rotational movements that are not second-synchronized, the hand movement control device 10 can reduce the load for keeping the accuracy of the timekeeping process. Meanwhile, by causing the second hand 241 not to start the time display from a position to which the second hand 241 points without second synchronization, the hand movement control device 10 can appropriately start the display synchronized with time through a simple-and-easy process. Therefore, this hand movement control device 10 can more simply and easily start the display operation with the hand 24 (second hand 241) that performs the display synchronized with time while operating/moving at fine time intervals.

Since the fast-forwarding speed of a hand is finite, it takes time to move the hand to a target position. In an electronic timepiece, by moving a hand to a target position corresponding to a point in time that is ahead of the current time by a required movement time and starting the time display at the timing at which the target point in time corresponding to the target position arrives, a time before the start of the time display can be kept short. However, it takes time and trouble to move a hand at fine time intervals and accurately determine the current time at all timings corresponding to the fine time intervals to start the display synchronized with time. In contrast, the hand movement control device 10 of this embodiment(s) can more simply and easily start the display operation with the hand 24 (second hand 241) that performs the display synchronized with time while operating/moving at fine time intervals.

Further, the controller 11 may calculate a required time for the fast-forward movement and determine the first point in time that is at least the required time ahead of the current time. By calculating the required time in advance and determining the first point in time, the display operation synchronized with time can be easily started after the simple fast-forwarding of the hand 24.

Alternatively, in response to the current time having passed the first point in time during the fast-forward movement, the controller 11 may add the reference period to the first point in time, the current time being measured by the timekeeping circuit 17 and in units of the reference period. Thus, by changing, as needed, the first point in time, and, by extension, the target position, during the fast-forwarding, the display synchronized with time can be easily started from a point in time corresponding to the target position.

Further, the reference period may be one second. The current time may be measured by the timekeeping circuit 17 in units of the reference period. By starting the display synchronized with time at an exact-second timing according to the temporal resolution of the timekeeping circuit 17, the control for the time display operation is started promptly within a possible range, and the accuracy of the time to be displayed is easily kept.

Further, the electronic timepiece 1 of this embodiment(s) includes the hand movement control device 10 described above, the second hand 241, the driver 20 that causes the second hand 241 to perform the rotational movement by the unit angle, and the timekeeping circuit 17 that measures the current time. This electronic timepiece 1 can simply and easily perform the process of starting the time display by shifting to the time display from display related to another function or the like while operating/moving the second hand 241 at time intervals finer than those at which the time is measured.

Further, the hand movement control method of this embodiment(s) includes (1) in a case of causing the second hand 241 to perform a display operation synchronized with time, outputting, to the driver 20, a signal to cause the second hand 241 to perform a rotational movement by a unit angle per unit period obtained by dividing a reference period by an integer of two or more. The signal to cause the second hand 241 to perform the rotational movement includes a first signal and a second signal. The first signal is a signal to cause the driver 20 to cause the second hand 241 to perform the rotational movement each time the reference period elapses based on the current time measured by the timekeeping circuit 17. The second signal is a signal to cause the driver 20 to cause the second hand 241 to perform the rotational movement each time the unit period elapses from the timing of the rotational movement caused by the first signal. The hand movement control method of this embodiment(s) further includes (2) in a case of causing the second hand 241 to move to a position corresponding to the current time and start the display operation, causing the second hand 241 to move to a position corresponding to a first point in time that is ahead of the current time and in units of the reference period and starting controlling the display operation from the first point in time. This prevents the control for the time display operation from being started at a timing not corresponding to second synchronization, and accordingly makes it possible to continue the control for the time display accurately and easily.

The present disclosure is not limited to the above embodiments, and various modifications can be made. For example, in the above, in order to fast-forward the hand 24 before the start of the time display, the movement amount and the required time are calculated based on the current time at the time of the fast-forward setting, but not limited thereto. The movement amount and the required time may be calculated by taking the influence of the current time, which changes during the required time for the fast-forwarding too, into account. In this case, calculation may be performed in multiple stages: the above-described calculation and a calculation of correction amounts for the movement amount and the required time to the position, with the movement of the hand 24 taken into account.

Further, in the above, the margin time is added to calculate the required time, but how to incorporate the margin time is not limited to this method. After the required time is calculated in the normal manner, the reference period, which is added to the target point in time, may be increased according to the magnitude of the fractional seconds.

Further, in the above, the display synchronized with time is the time display itself, but not limited thereto. For example, it may be timer display of displaying the remaining time to a specific point in time.

Further, in the above, the sweep movement of the second hand 241 has been described, but the present disclosure is not limited thereto. The present disclosure is applicable to any display operation of any hand, provided that the display operation is display synchronized with time and performed by the hand that operates/moves at intervals shorter than the timekeeping intervals. Examples of any display operation of any hand include a decorative operation of a hand. Further, the electronic timepiece 1 may not be a wristwatch. It may be another type of timepiece, such as a table clock or a pocket watch.

Further, in the above, the reference period is one second, but not limited thereto. For example, the timekeeping circuit 17 may measure time in units of 0.5 seconds (2 Hz), and in response to synchronization signals for this time measurement, the sweep movement may be performed by six timer interrupts per 0.5 seconds.

Further, in the above, the computer-readable medium storing the program(s) 131 for the hand movement control of the present disclosure is the storage 13 composed of a nonvolatile memory, such as an HDD and/or a flash memory, but not limited thereto. As the non-transitory computer-readable storage medium, another type of nonvolatile memory, such as an MRAM, or a portable storage medium, such as a CD-ROM or a DVD disk, may be used. Further, as a medium that provides data of the programs of the present disclosure via a communication line, a carrier wave is also applicable to the present disclosure. The specific configurations/components, contents of and procedures for the processes, and so forth described in the above embodiments can be changed as appropriate without departing from the scope of the present disclosure. The scope of the present invention includes the scope of claims and their equivalents.

This application claims the benefit of Japanese Patent Application No. 2025-048774, filed Mar. 24, 2025 which is hereby incorporated by reference wherein in its entirety.

1. A hand movement control device comprising a processor configured to, in a case of causing a hand to perform a display operation synchronized with time, output, to a driver, a signal to cause the hand to perform a rotational movement by a unit angle per unit period obtained by dividing a reference period by an integer of two or more,
wherein the signal includes a first signal to cause the driver to cause the hand to perform the rotational movement each time the reference period elapses based on a current time measured by a timing module, and a second signal to cause the driver to cause the hand to perform the rotational movement each time the unit period elapses from a timing of the rotational movement caused by the first signal, and
wherein in a case of causing the hand to move to a position corresponding to the current time and start the display operation, the processor causes the hand to move to a position corresponding to a first point in time that is ahead of the current time and in units of the reference period and starts controlling the display operation from the first point in time.

2. The hand movement control device according to claim 1, wherein the processor calculates a required time by the hand to move to a position corresponding to a second point in time that is ahead of the current time and in units of the reference period and determines the first point in time that is at least the required time ahead of the current time.

3. The hand movement control device according to claim 1, wherein in response to the current time having passed the first point in time while the hand is moving to the position corresponding to the first point in time, the processor adds the reference period to the first point in time, the current time being measured by the timing module and in units of the reference period.

4. The hand movement control device according to claim 1,
wherein the reference period is one second, and
wherein the current time is measured by the timing module in units of the reference period.

5. An electronic timepiece comprising:
the hand movement control device according to claim 1;
the hand;
the driver that causes the hand to perform the rotational movement by the unit angle; and
the timing module that measures the current time.

6. An electronic timepiece comprising:
the hand movement control device according to claim 2;
the hand;
the driver that causes the hand to perform the rotational movement by the unit angle; and
the timing module that measures the current time.

7. An electronic timepiece comprising:
the hand movement control device according to claim 3;
the hand;
the driver that causes the hand to perform the rotational movement by the unit angle; and
the timing module that measures the current time.

8. An electronic timepiece comprising:
the hand movement control device according to claim 4;
the hand;
the driver that causes the hand to perform the rotational movement by the unit angle; and
the timing module that measures the current time.

9. A hand movement control method comprising, in a case of causing a hand to perform a display operation synchronized with time, outputting, to a driver, a signal to cause the hand to perform a rotational movement by a unit angle per unit period obtained by dividing a reference period by an integer of two or more,
wherein the signal includes a first signal to cause the driver to cause the hand to perform the rotational movement each time the reference period elapses based on a current time measured by a timing module, and a second signal to cause the driver to cause the hand to perform the rotational movement each time the unit period elapses from a timing of the rotational movement caused by the first signal, and
wherein the hand movement control method further comprises, in a case of causing the hand to move to a position corresponding to the current time and start the display operation, causing the hand to move to a position corresponding to a first point in time that is ahead of the current time and in units of the reference period and starting controlling the display operation from the first point in time.

10. The hand movement control method according to claim 9, further comprising calculating a required time by the hand to move to a position corresponding to a second point in time that is ahead of the current time and in units of the reference period and determining the first point in time that is at least the required time ahead of the current time.

11. The hand movement control method according to claim 9, further comprising, in response to the current time having passed the first point in time while the hand is moving to the position corresponding to the first point in time, adding the reference period to the first point in time, the current time being measured by the timing module and in units of the reference period.

12. The hand movement control method according to claim 9,
wherein the reference period is one second, and
wherein the current time is measured by the timing module in units of the reference period.

13. A non-transitory computer-readable storage medium storing a program causing, of an electronic timepiece including a hand, a driver that causes the hand to perform a rotational movement by a unit angle, and a timing module that measures a current time, a computer to, in a case of causing a hand to perform a display operation synchronized with time, output, to a driver, a signal to cause the hand to perform a rotational movement by a unit angle per unit period obtained by dividing a reference period by an integer of two or more,
wherein the signal includes a first signal to cause the driver to cause the hand to perform the rotational movement each time the reference period elapses based on a current time measured by a timing module, and a second signal to cause the driver to cause the hand to perform the rotational movement each time the unit period elapses from a timing of the rotational movement caused by the first signal, and
wherein the program further causes the computer to, in a case of causing the hand to move to a position corresponding to the current time and start the display operation, cause the hand to move to a position corresponding to a first point in time that is ahead of the current time and in units of the reference period and start controlling the display operation from the first point in time.

14. The non-transitory computer-readable storage medium according to claim 13, wherein the program further causes the computer to calculate a required time by the hand to move to a position corresponding to a second point in time that is ahead of the current time and in units of the reference period and determine the first point in time that is at least the required time ahead of the current time.

15. The non-transitory computer-readable storage medium according to claim 13, wherein the program further causes the computer to, in response to the current time having passed the first point in time while the hand is moving to the position corresponding to the first point in time, add the reference period to the first point in time, the current time being measured by the timing module and in units of the reference period.

16. The non-transitory computer-readable storage medium according to claim 13,
wherein the reference period is one second, and
wherein the current time is measured by the timing module in units of the reference period.
